(19) United States
(12) Patent Application Publication
(10) Pub. No.: US 2007/0038794 A1
(43) Pub. Date: Feb. 15, 2007

(54) Method and system for allocating a bus

(76) Inventors: Brian T. Purcell, Tomball, TX (US); Melvin K. Benedict, Magnolia, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/200,670

(22) Filed: Aug. 10, 2005

(51) Int. Cl. G06F 13/36

(52) U.S. Cl. 710/306

(57) ABSTRACT

Methods and apparatuses are disclosed for allocating a bus in a computer system. In one embodiment, an apparatus comprises: a bus divided into at least two segments, a first segment of the bus routed to a first device, a second segment of the bus routed to an adapter capable of further dividing the second segment into multiple sub-segments, where the adapter routes the multiple sub-segments between the first device and a second device.

### BACKGROUND

Computers are ubiquitous in today's society and each new generation of computers offers advantages over previous generations. Since the pace at which new generations of computers are developed and sold can be relatively short, it is not uncommon for computers to become outdated rather quickly. Computer companies strive to keep pace with changing technology trends. In part, this endeavor includes deciding which technologies to offer in the latest computers based on consumer marketing trends. Unfortunately, these decisions often fix the configuration of peripheral devices, including fixing the potential configurations for Peripheral Component Interconnect (PCI) Express® resources. Consumer needs change rapidly and unexpectedly as new technology becomes available, and therefore fixed configuration PCI systems are often undesirable to consumers.

### BRIEF SUMMARY

Methods and apparatuses are disclosed for allocating a bus in a computer system. In one embodiment, an apparatus comprises: a bus divided into at least two segments, a first segment of the bus routed to a first device, a second segment of the bus routed to an adapter capable of further dividing the second segment into multiple sub-segments, where the adapter routes the multiple sub-segments between the first device and a second device.

### BRIEF DESCRIPTION OF THE DRAWINGS

For a detailed description of exemplary embodiments of the invention, reference will now be made to the accompanying drawings in which:

FIG. 1 illustrates an exemplary computer system;

FIG. 2 illustrates an exemplary serial bus link;

FIG. 3A illustrates an exemplary system including a plug-in configuration card;

FIG. 3B illustrates another exemplary system including a plug-in configuration card;

FIG. 3C illustrates an exploded view of an exemplary plug-in configuration card;

FIG. 3D illustrates another exploded view of an exemplary plug-in configuration card;

FIG. 3E illustrates yet another exemplary system including a plug-in configuration card;

FIG. 4 illustrates an exemplary system including a switch;

FIG. 5 illustrates another exemplary system with the bus routed to a configuration mechanism;

FIG. 6 illustrates an exemplary algorithm; and

FIG. 7 illustrates an exemplary stub connection.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Furthermore, the term “bridge” is intended to mean any circuitry that provides the origination point for a bus structure. In addition, the term “stub” is intended to refer to an excess or unused portion of electrical connection. Thus, stubs may exist, for example, in vertical connections on printed circuit boards, as well as within integrated circuits where a conductor may be electrically unconnected to a signal and therefore the conductor may be unused.

### DETAILED DESCRIPTION

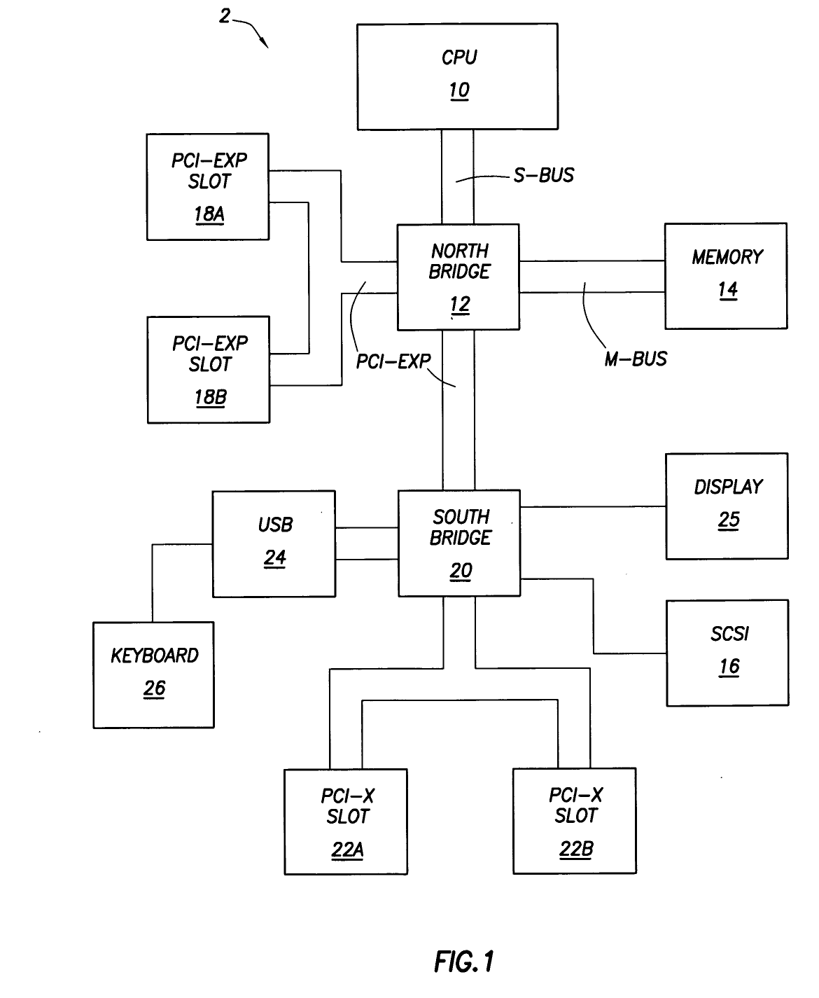

FIG. 1 illustrates a block diagram of an exemplary computer system 2. Computer system 2 includes a central processing unit (CPU) 10 that couples to a bridge logic device 12 via a system bus (S-BUS). Bridge logic device 12 may be referred to as a “North bridge.” In some embodiments, bridge 12 couples to a memory 14 by a memory bus (M-BUS). In other embodiments, however, CPU 10 includes an integrated memory controller, and memory 14 connects directly to CPU 10.

Bridge 12 also couples to PCI-Express® slots 18 A-B using the PCI-Expressing® bus standard as disclosed in “PCI-Express Base Specification 1.0a,” available from the Peripheral Component Interconnect (PCI) Special Interest Group (PCI-SIG) and incorporated herein by reference. Although system 2 is shown with two slots (slots 18A-B) for the sake of clarity, is should be understood that many slots are possible. Slots 18A-B may physically reside on the same printed circuit board (also referred to as a “system board” or “mother board”) as CPU 10. Alternatively slots 18A-B may be located on a riser or expansion board mounted on the system board or backplane, as is the case with “blade” type systems comprising a thin, modular electronic circuit board, containing one, two, or more microprocessors and memory. Many desktop computer systems provide ample space on the system board for slots 18A-B. In a rack mounted computer system however, where real estate on the system board may be limited, slots 18A-B may reside on a riser board that plugs into the system board.

As will be described in the context of additional Figures below, slots 18A-B represent physical connectors that printed circuit board (PCB) devices, such as peripheral devices, will be plugged into. The configuration of slots 18A-B based on the presence of various devices in slots 18A-B will be discussed in more detail below.

Additionally, bridge 12 couples to an additional bridge 20 (sometimes referred to as the “South bridge”). The connection between bridges 12 and 20 may include a variety of bus types including PCI-Express® and Hyper Transport, for example. Bridge 20 is capable of providing various different busing schemes. For example, bridge 20 couples to PCI-extended (PCI-X) slots 22 A-B using a PCI-X bus and couples to a universal serial bus (USB) connector 24 via a USB. A keyboard 26 may be coupled to system 2 via USB connector 24. Bridge 20 also couples to a storage controller 16 that in turn connects to devices like the hard drives. Controller 16 may include Serial ATA (SATA), Integrated Drive Electronics (IDE), Serial Attached SCSI (SAS) or Small Computer System Interface (SCSI). CPU 10 executes software stored in memory 14 or other storage devices. Under the direction of the software, CPU 10 may accept commands from an operator via keyboard 24 or an alternative input device, and may display desired information to the operator via a display 25 or an alternative output device. Bridge 12 coordinates the flow of data between components such as between CPU 10 and slots 18A-B or between CPU 10 and memory 14. Memory 14 stores software and data for rapid access and often complements the type of M-BUS implemented. For example, some busing standards use dual data rate (DDR) principles, and therefore memory 14 would then be DDR-compliant. The SCSI controller 16 may be a controller that permits connection for additional storage devices to be accessed by system 2.

Bridge 20 coordinates the flow of data between bridge 12 and the various devices coupled to bridge 20. For example, signals from the keyboard 26 may be sent along the USB via USB connector 24 to bridge 20, and from bridge 20 to bridge 12 via the PCI-Express® bus.

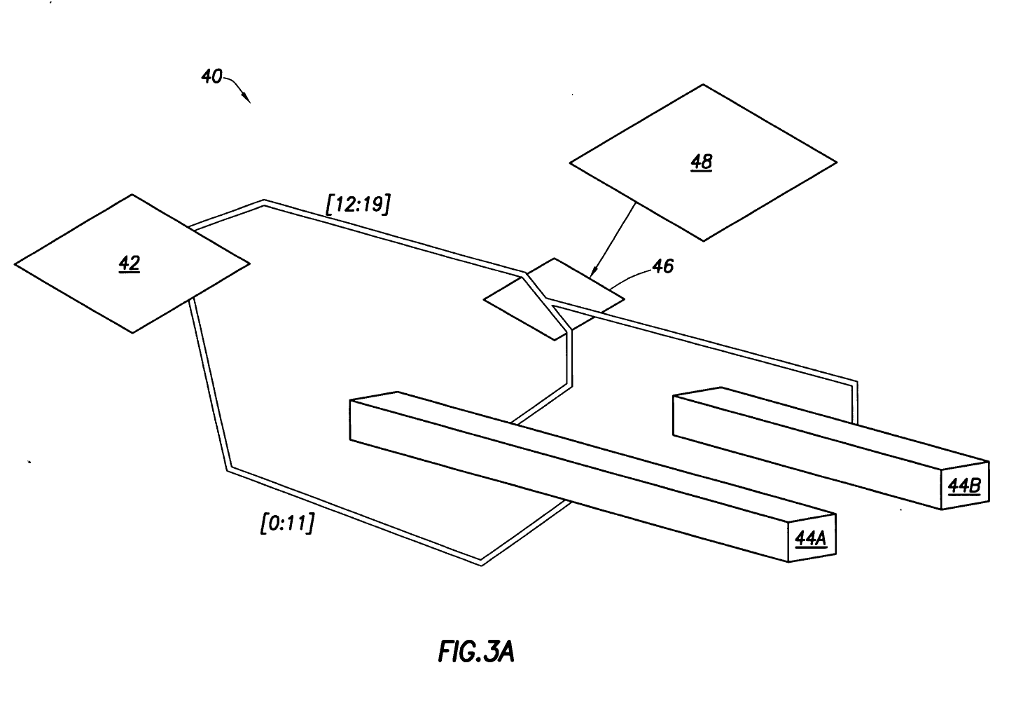

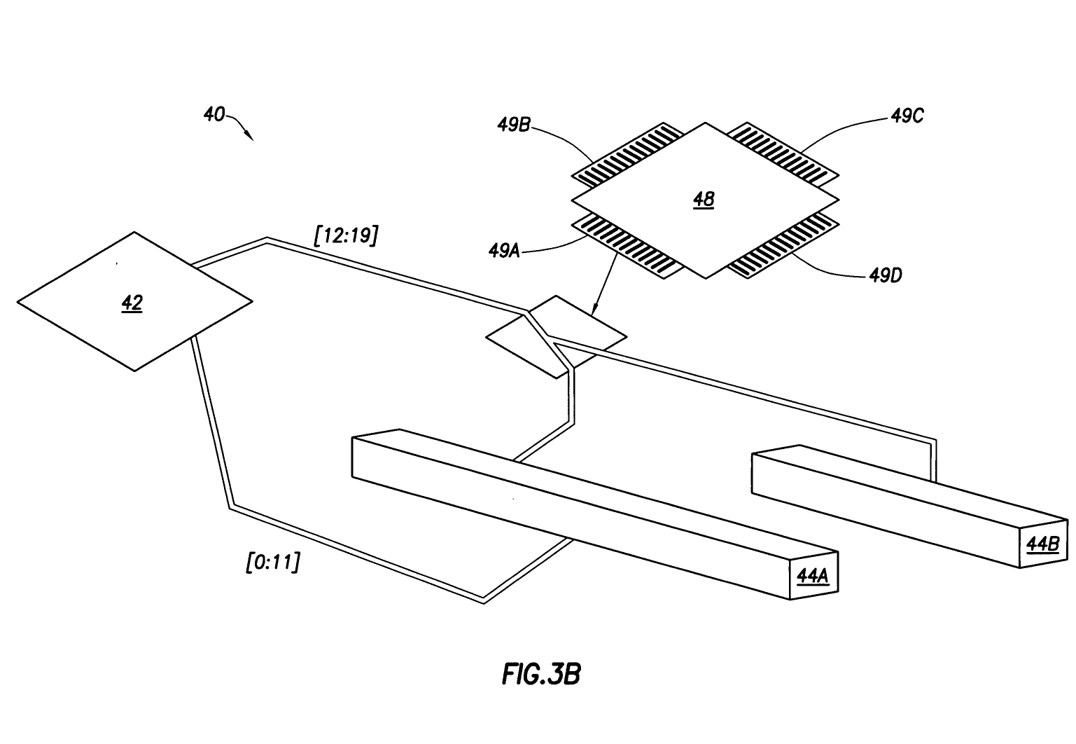

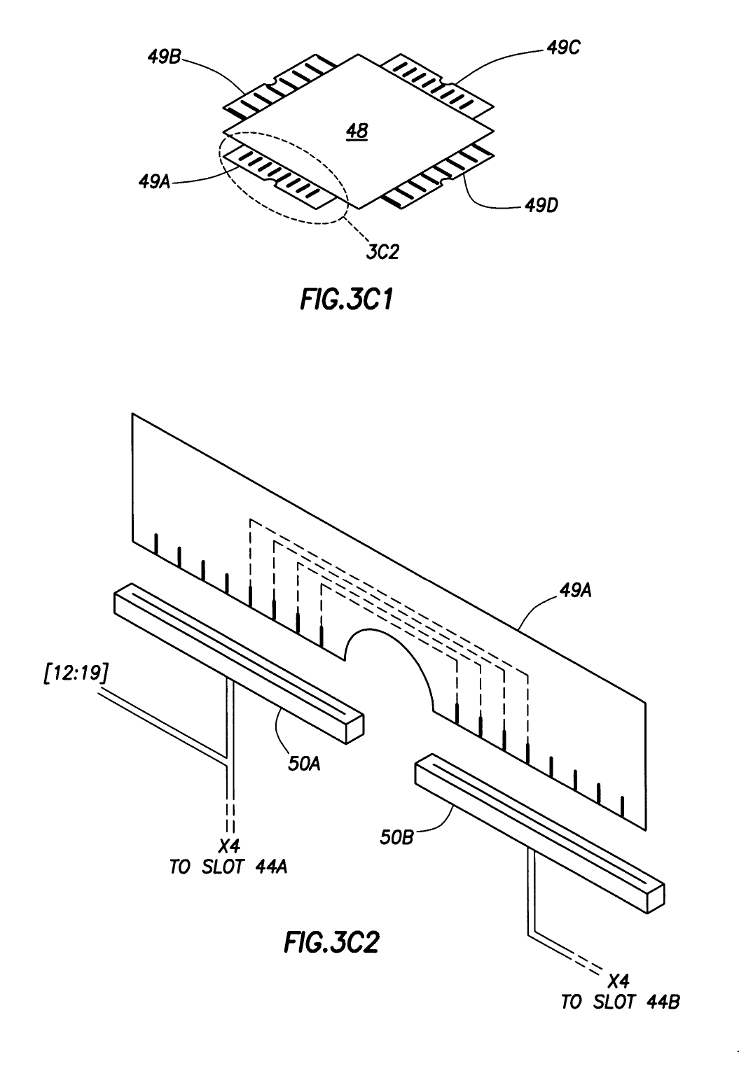

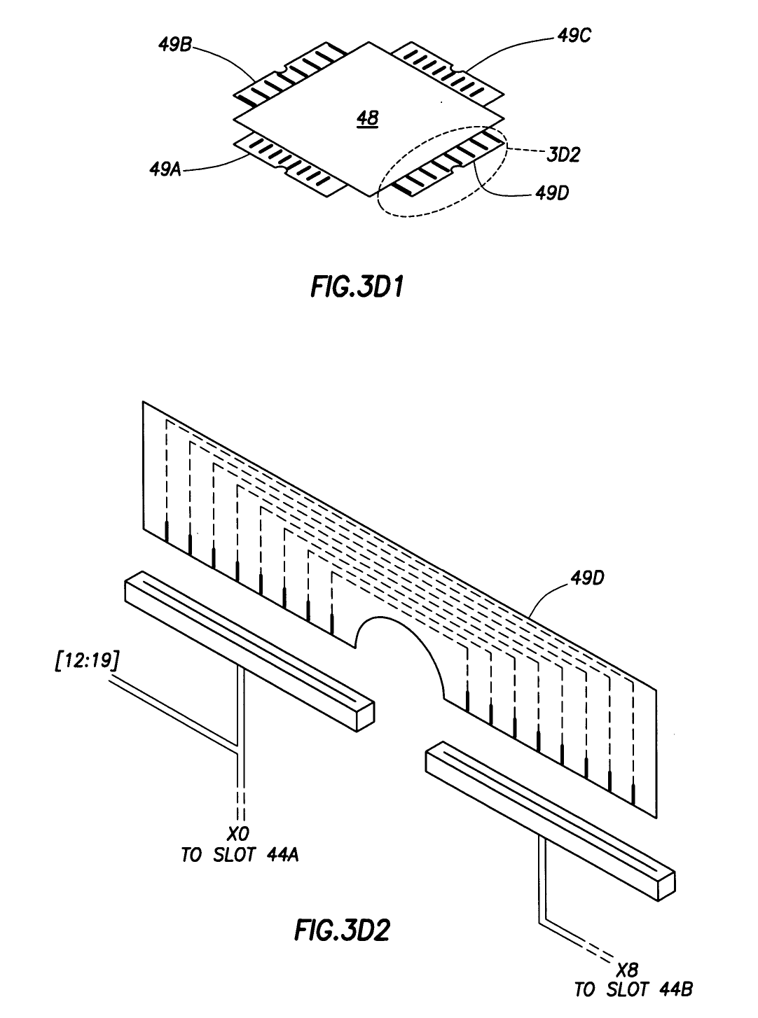

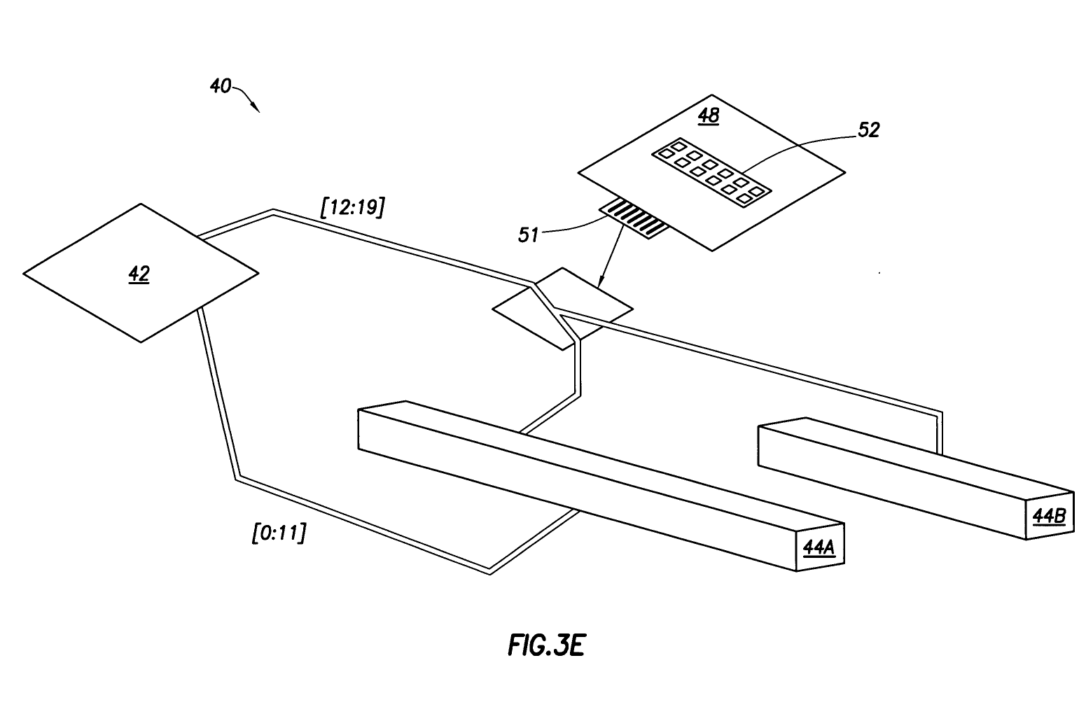

As set forth in more detail below, bridge 20 configures the routing of the PCI-Express® bus between devices inserted into slots 18A-B. This configuration mechanism may physically reside within the circuitry that comprises bridge 20, or alternatively, this configuration mechanism may be part of an external plug-in board that hardwires the PCI-Express® bus between the various slots 18A-B, as illustrated in FIGS. 3C and 3D.

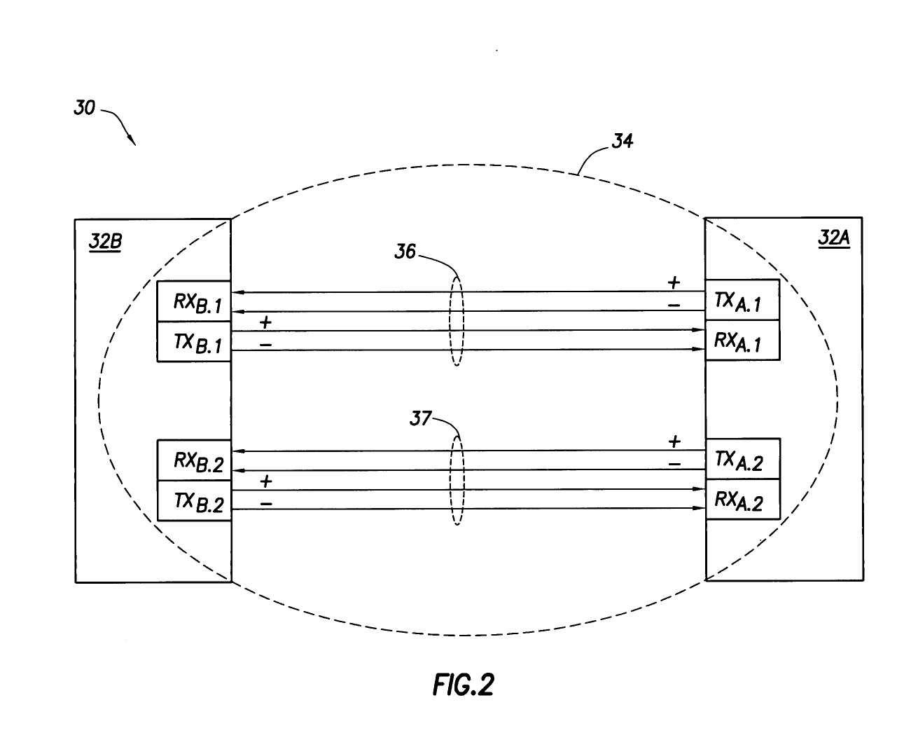

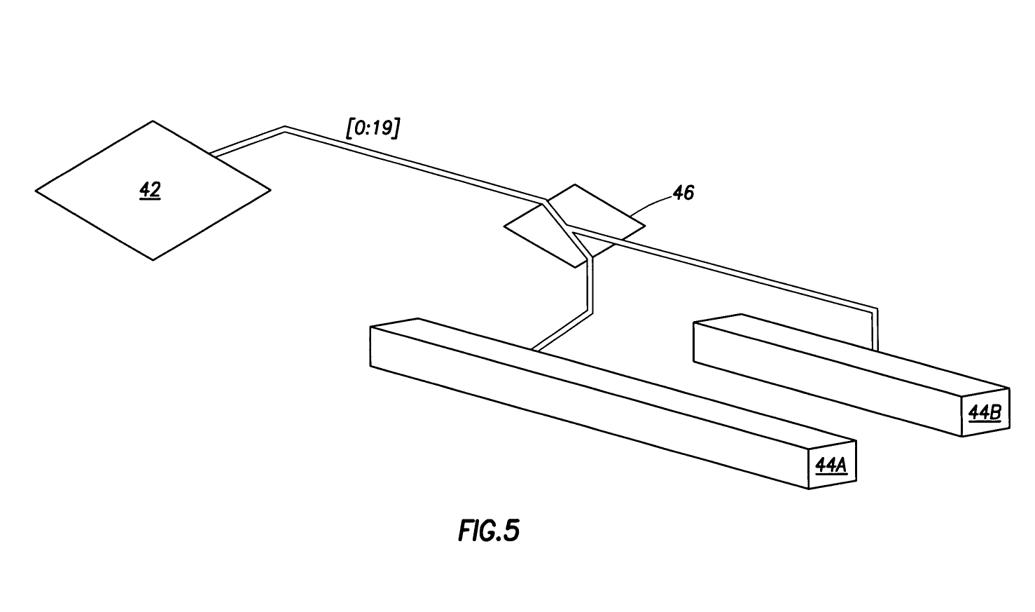

PCI-Express® represents a recent trend in busing schemes to move away from a “shared” bus toward a point-to-point connection. That is, rather than a single parallel data bus through which all data is routed at a set rate (as is the case, for example, on PCI or PCI-X), a PCI-Express-compliant bus comprises a group of point-to-point conductors, in which data is sent serially and all the conductors are individually clocked. Although the focus of some of the Figures involves the PCI-Express® bussing standard, other embodiments may include fiber optic and wireless communication links. FIG. 2 depicts an exemplary system 30 comprising an exemplary serial link that may be used to implement the PCI-Express® bus of FIG. 1. While system 30 may implement the PCI Express® standard, it is also capable of implementing any serial communications including serial connectors that automatically detect bus needs during a training period, which is described in more detail below with regard to FIG. 5. System 30 includes peripheral devices 32A-B communicating with each other serially. This serial communication medium is sometimes referred to as a link 34. Device 32A may be a PCI-Express® compliant device inserted into slots 18A-B. Device 32B may comprise a bridge that is PCI-Express® compliant, such as bridge 12.

Device 32A includes a driver or transmitter TX_{A.1} and device 32B includes a receiver RX_{B.1}. The connection between each transmitter and receiver in system 30 comprises a pair of differential signal lines, designated as + and − respectively. Although there are two lines between TX_{A.1} and RX_{B.1} carrying differential signals, the difference between the two differential signals yields a single signal of interest with a minimal amount of noise.

As indicated in FIG. 2 by the direction of the arrows, the lines between TX_{A.1} and RX_{B.1} communicate information from device 32A to device 32B. Similarly, device 32B communicates information to device 32A using transmitter TX_{B.1} and receiver RX_{A.1} as indicated by the arrows. In this manner, PCI-Express® communication between devices 32A-B is often referred to as a “dual-simplex” because data is sent on one differential pair of data lines (i.e., the + and − lines connecting TX_{A.1} and RX_{B.1}), and data is received on another differential pair of data lines (i.e., the + and − lines connecting TX_{B.1} and RX_{A.1}). The two pairs of data lines that allow information to be conveyed back and forth between devices 32A-B are often referred to as “lanes.” FIG. 2 shows the link 34 with one lane 36 coupled to transmitters TX_{A.1} and TX_{B.1} and also coupled to receivers RX_{B.1} and RX_{A.1}. Likewise, link 34 includes another lane 37 coupled to transmitters TX_{A.2} and TX_{B.2} and also coupled to receivers RX_{B.2} and RX_{A.2}. Although link 34 includes two lanes 36 and 37, any number of lanes are possible where the number of lanes contained therein determines the size of the link 34. For example, link 34 is shown containing the lanes 36 and 37 and therefore the link 34 is referred to as a “by two” link (sometimes denoted as “x2”).

As discussed above with regard to FIG. 1, bridge 12 may interface to multiple bus technologies and may be implemented as an integrated circuit (IC). Suitable vendors and models for such an integrated circuit include the nForce Professional by Nvidia. Regardless of the model of integrated circuit implemented as bridge 12, the actual number and size of the multiple links that bridge 12 implements in practice is often finite because of the number of pins that the integrated circuit has. Consequently, the number and configuration of PCI-Express® links may be limited. As such, bridge 12 may be configured to provide one link to slots 18A-B and another link to bridge 20 as indicated in FIG. 1. In this embodiment, both bridges 12 and 20 are capable of allocating lanes according to the needs of the devices that are coupled to them.

As would be evident to one of ordinary skill in the art, bridge 12 may be implemented in many forms. For example, in some embodiments, bridge 12 may be part of the same IC as CPU 10. Likewise, in other embodiments, bridge 12 may be implemented on the same IC as bridge 20.

FIG. 3A depicts an exemplary link 40 including bridge 42 coupled to slots 44A-B via a plurality of lanes as shown. In link 40, lanes 0 through 11 are routed to slot 44A making it, at a minimum, a x12 connector. The remainder of lanes 12-19, however, may be routed using an adapter 46. It should be understood that although link 40 represents one embodiment of the present invention, other lane and slot configurations are possible. For example, as illustrated with regard to FIG. 5, lanes 0-19 all may be routed to the configuration adapter 46, which then routes the lanes between slots 44A-B.

The ultimate configuration of the lanes routed through adapter 46 may depend on a board 48 that may be plugged into adapter 46. Board 48 is a PCB that may be inserted into adapter 46 to achieve a variety of configurations. Board 48 may include conductive pathways for lanes 12-19 and thereby hardwire lanes 12-19 between slots 44A-B. The desired allocation of lanes 12-19 may depend upon the peripheral devices that are inserted into slots 44A-B. For example, a device inserted into slot 44A may be able to operate with twelve lanes (i.e., a x12 connection), whereas the device inserted into slot 44B may require the eight remaining lanes (i.e., a x8 connection). In this example, board 48 may be inserted into adapter 46 to effectuate the desired connection.

In some embodiments of board 48, the conductive pathways exist on multiple conductive layers and each conductive layer may provide a separate lane configuration to slots 44A-B. For example, board 48 may include multiple sides 49A-D, as illustrated in FIG. 3B where each side 49A-D may be connected to a separate conductive layer on board 48. Connecting each side to a separate conductive layer provides a more compact implementation of board 48 rather than routing each side on a single conductive layer within board 48. Regardless of the number of routing layers implemented, each side 49A-D may provide a separate lane configuration.

FIGS. 3C and 3D represent exemplary configurations for conductors of sides 49A and 49D respectively. Referring to FIG. 3C, an exploded view of side 49A is depicted where side 49A seats into slots 50A and 50B. Different routing configurations are realized by inserting the various sides 49A-D into slots 50A-B. In some embodiments, side 49A includes conductive routing (either on the same conductive layers as sides 49B-D or, alternatively, on separate conductive layers) between the portions of side 49A that are seated into slots 50A-B. For example, side 49A may route four lanes from slot 50A to slot 50B, and therefore provide four lanes to slot 44B shown in FIG. 3B. In this manner, slot 44B would provide a x4 connection, while the other four lanes would be provided to slot 44A making it a x16 connection. In this exemplary embodiment, slot 44A would become a x16 connector, capable of accommodating higher bandwidth PCI-Express® devices, such as graphics cards. Further, slot 44B would become a x4 connector and remain available to accommodate lower bandwidth PCI-Express® devices requiring a x4 connection. One important aspect of the embodiments illustrated in FIGS. 3C and 3D is that the PCI-Express slots 44A and 44B are not eliminated in the reconfiguration of the lanes, and therefore the number of peripheral devices that may be inserted into the system is not limited when because of the reconfiguration of bus lanes.

Referring to FIG. 3D, an exploded view of side 49D is depicted where side 49D routes all eight of lanes 12-19 from slot 50A to slot 50B. Thus, with side 49D of board 48 seated into slots 50A-B, slot 44B in FIG. 3B will provide a x8 connection, while slot 44A would provide its default x12 connection.

TABLE 1

Number of Lanes Allocated

| Configuration | Slot 44A | Slot 44B |
|---|---|---|
| | 20 | 0 |
| | 19 | 1 |
| Side 49B | 18 | 2 |
| | 17 | 3 |
| Side 49A | 16 | 4 |
| | 15 | 5 |
| Side 49C | 14 | 6 |
| | 13 | 7 |
| Side 49D | 12 | 8 |

Table 1 depicts the total number of lanes 12-19 (shown in FIG. 3A) allocated between slots 44A-B by operation of board 48. As indicated in Table 1, any one of sides 49A D may produce any one of nine configurations by routing the conductive layers accordingly. For example, Table 1 depicts the embodiment shown in FIG. 3C where side 49A produces a x16 connection for devices inserted in slot 44A and a x4 connection for devices inserted in slot 44B. Likewise, Table 1 also depicts the embodiment shown in FIG. 3D where side 49D produces a x12 connection for devices inserted in slot 44A and a x8 connection for devices inserted in slot 44B.

In other embodiments, board 48 may include a single side 51 for connecting to adapter 46 as depicted in FIG. 3E. This embodiment also may include a bank of dip switches 52 such that the lane allocation shown in Table 1 may be achieved by configuring dip switches 52 accordingly. As would be understood by one of ordinary skill in the art, dip switches 52 may be replaced by pull-up or pull-down resistors to achieve the lane allocation shown in Table 1.

Since both slots 44A-B may have the 20 lanes allocated between them, the physical connectors used to implement slots 44A-B are made larger than the size of the link provided to slots 44A-B in order to support the 20 available lanes in link 40. For example, if adapter 46 provides 4 lanes to the devices inserted into slot 44A allowing a x16 connection, then the devices inserted into slot 44B would get a x4 connection despite the fact that the physical connector of slot 44B may be capable of accommodating a x8 connection. The PCI-Express® specification refers to this as “down shifting.”

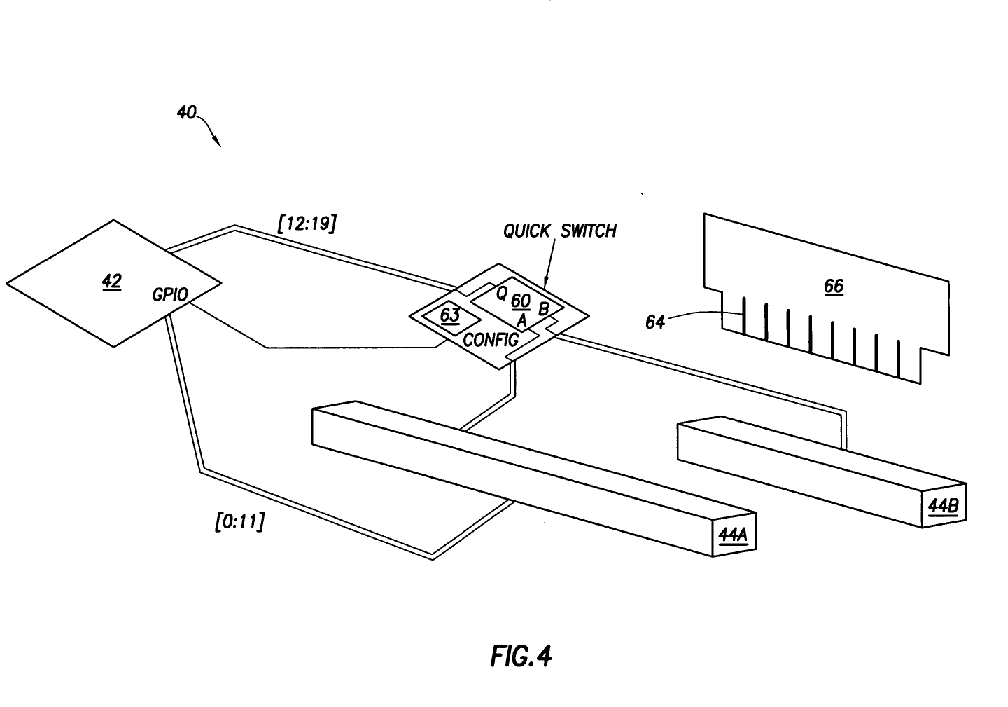

FIG. 4 represents another embodiment of the present invention where a switch 60 is implemented in link 40. Switch 60 may allocate lanes 12-19 dynamically between slots 44A-B. Switch 60 includes a CONFIG pin that couples to a controller in link 40. As shown in FIG. 4, the CONFIG pin may couple to a General Purpose Input Output (GPIO) connection of the bridge 42. The CONFIG pin may further couple to a register 63, where register 63 couples to switch 60. In some embodiments, register 63 receives configuration information, for example in the form of a serial bit stream, from the GPIO connection and configures switch 60 with the received configuration information.

The particular configuration information may be dependent upon a presence detect pin 64 that resides on a peripheral device 66 that is inserted into one of the slots 44A-B. For example, bridge 42 may poll the devices (such as device 66) that are inserted into slots 44A-B to determine information from the presence detect pin 64. Pin 64 may indicate that device 66 requires all eight of the lanes 12-19 and therefore switch 60 then may dynamically allocate lanes 12-19 to slot 44B to reflect the needs of device 66. This information may be conveyed to bridge 42 via a multi-bit code where each bit in the code represents a presence detect pin from each device in the various slots of the system. In this manner, the bridge 42 may allocate lanes on the fly based on programming within link 40. By asserting the CONFIG pin with bridge 42, lanes 12-19 may be dynamically allocated among slots 44A-B.

In some embodiments, switch 60 may be implemented as a series of multiplexers or combinational logic.

FIG. 5 represents an alternative bus allocation scheme where the entire bus (i.e., lanes 0-19) is routed directly to the adapter 46, and adapter 46 further routes the bus lanes between slots 44A-B based on the devices that exist within the slots. Adapter 46 may take many forms, such as active lane configuration (such as switch 60 illustrated in FIG. 4), or passive configuration (such as board 48 illustrated in FIGS. 3B-3D). Regardless of whether the bus allocation is performed passively or actively, the bus may be allocated according to various configuration rules such as providing the maximum bandwidth to each devices in each slot based on their needs and total available bus. Further, the configuration rules may include monitoring (for example, by bridge 42) average bus usage by devices in the slots and allocating based on usage. In addition, the configuration rules may include a priority scheme for the various devices that are in the slots such that if a system critical device in one slot needs bus resources it has an opportunity to secure those bus resources before they are delegated to another device in a different slot.

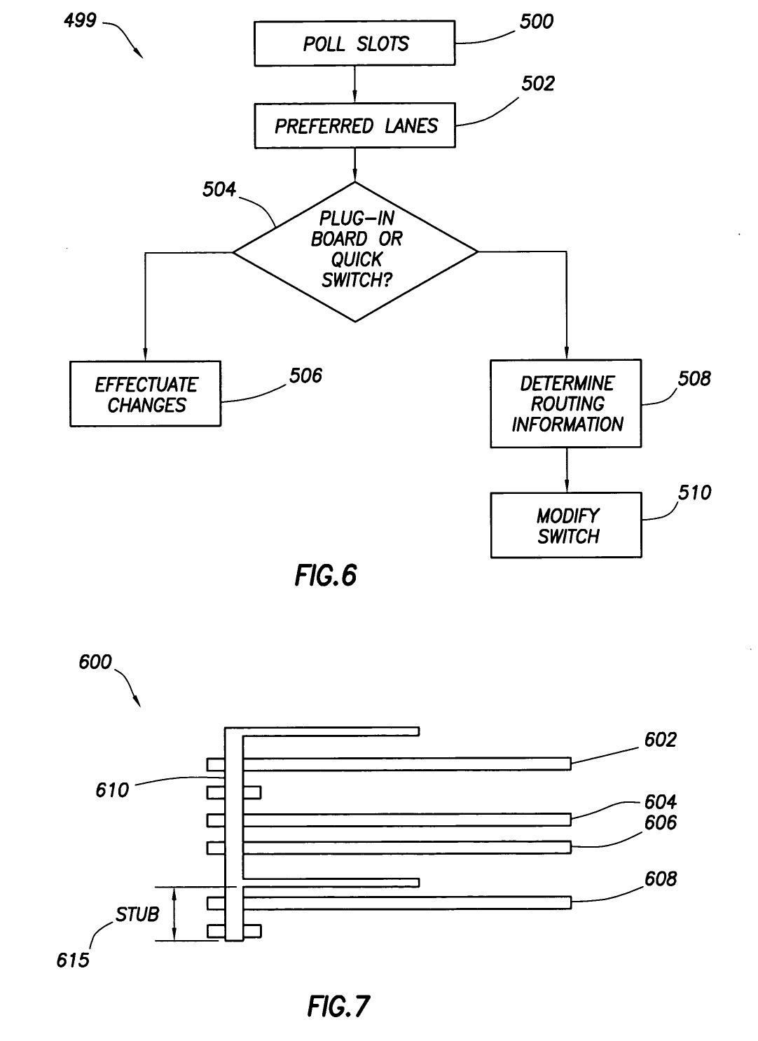

FIG. 6 depicts an exemplary algorithm 499 that may be employed to allocate bus lanes. In block 500, bridge 42 may poll slots 44A-B to determine if peripheral devices have been inserted that require more lanes than the present configuration. This polling may be performed by hardware (such as bridge 42) or software running on system 2 checking both the bandwidth requirements of the inserted device as well as their lane configurations. The peripheral devices inserted into slots 44A-B may include one or more presence detect pins (as was illustrated in FIG. 4) that indicate the required configuration for each device. As bridge 42 polls the slots, the presence detect pins on the various devices may be compared to determine if lanes may be reallocated among the slots based on the device needs.

The functions performed in block 500 are sometimes referred to as the training period described above. For example, as alluded to above, a graphics card may be inserted into slot 44A in order to perform mathematical computations. This graphics card may require more lanes than the other devices that are typically inserted into slots 44A-B, and thus link 40 may need to “train” itself for the newly inserted graphics card.

In block 502, the preferred number of lanes for this added device is conveyed to bridge 42. This may be, for example, a multi-bit code generated as a result of the comparing the presence detect pins of the various devices. In this manner, if one device can function with fewer lanes than its current allotment, and another device requires more lanes, the preferred number of lanes for each device may be conveyed to bridge 42 as a result of receiving the multi-bit code.

Per block 504, bridge 42 may then detect whether adapter 46 includes a plug-in board, or alternatively, bridge 42 may detect that a switch is present. In the event that a plug-in board is utilized, the changes may be effectuated per the configuration of the plug-in board as indicated in block 506 and illustrated in FIGS. 3C and 3D.

In the event that a switch is utilized, then in block 508, link 40 determines the required routing information by consulting the devices inserted in slots 44A-B, for example, through a multi-bit code generated from comparing the presence detect pins of each device inserted in slots 44A-B. Once the routing information is known by link 40, switch 60 is modified to allocate the desired routing configuration as represented in block 510. In some embodiments, as shown in FIG. 4, the multi-bit code is stored in register 63 so that switches (such as switch 60) may be adjusted to allocate the lanes dynamically.

The various embodiments of the present invention may reduce the number of “stubs” in a system. FIG. 6 depicts a cross section of a printed circuit board 600 of the type used to construct system 2 where stubs may be prevalent. Traces 602-606 are conductive pathways that exist on separate layers of printed circuit board 600. Traces 602-606 are electrically isolated from each other and are used to connect electrical devices mounted on printed circuit board 600 by connecting to a vertical conductive pathway 610, which is sometimes referred to as a via. When vias are formed in printed circuit boards, however, they are vertically formed through printed circuit board and there is an excess vertical portion 615, often referred to as a stub. This stub portion is undesirable because it may cause signal reflections and affect the integrity of signals propagating through the via. In practice, trace 602 may represent the portion of lanes 12-19 that are between bridge 42 and adapter 46, while trace 604 may represent the portion of lanes 12-19 that are between adapter 46 and connector 44B. If these two portions of lanes 12-19 are coupled together as illustrated in FIG. 6, then signal integrity of lanes 12-19 may be compromised. The single conductive layer embodiment of board 48 (shown in FIGS. 3A-3E) and switch 60 may eliminate coupling the lanes together in this manner, and be particularly useful in high speed signaling environments.

While various embodiments of the present invention have been shown and described, modifications thereof can be made by one skilled in the art without departing from the spirit and teachings of the invention. For example, although FIG. 2 discloses differential communication between devices 32A-B, single ended communication is also possible.

The embodiments described herein are exemplary only, and are not intended to be limiting. Accordingly, the scope of protection is not limited by the description set out above. Each and every claim is incorporated into the specification as an embodiment of the present invention.

What is claimed is:

1. A computer system comprising:
a bus divided into at least two segments;
a first segment of the bus routed to a first device; and
a second segment of the bus routed to an adapter capable of further dividing the second segment into multiple sub-segments, wherein the adapter routes the multiple sub-segments between the first device and a second device.

2. The computer system of claim 1, wherein the first device requires greater bus capacity than the second device.

3. The computer system of claim 1, wherein the adapter comprises a switching circuit that actively divides and routes the second segment between the first and second devices.

4. The computer system of claim 2, wherein the switching circuit communicates with a bridge circuit to determine division and routing configuration of the second segment.

5. The computer system of claim 1, wherein the adapter passively divides and routes the second segment between the first and second devices.

6. The computer system of claim 1, wherein the routing of the multiple sub-segments occurs as a result of an apparatus chosen from the group consisting of pull-up resistors, pull-down resistors, configurable DIP switches, physical routing of a plug-in card, or a configuration register.

7. The computer system of claim 4, wherein the switch circuit determines routing information based on information conveyed from the first device.

8. The computer system of claim 7, wherein the information conveyed from the first device is from a presence detect pin.

9. The computer system of claim 1, wherein the adapter comprises a printed circuit board (PCB).

10. The computer system of claim 9, wherein the PCB couples portions of the second segment of the bus to each other.

11. The computer system of claim 9, wherein the PCB comprises a plurality of configuration options.

12. The computer system of claim 10, wherein each configuration option of the PCB utilizes a separate conductive layer.

13. The computer system of claim 11 above, wherein different sides of the PCB produce different configuration options.

14. The computer system of claim 1, wherein the adapter comprises a register capable of storing configuration information from a bridge circuit.

15. The computer system of claim 14, wherein configuration information stored in the register is conveyed to the adapter via a multi-bit code.

16. A method of allocating a bus, comprising:
dividing the bus into a first segment and a second segment;
routing the first segment to a first device; and
routing the second segment to an adapter, wherein the adapter divides the second segment into multiple sub-segments, wherein the adapter routes the multiple sub-segments between the first device and a second device.

17. The method of claim 16, wherein the bus capacity required for the first device is greater than the bus capacity of the second device.

18. The method of claim 16, further comprising actively dividing and routing the second segment between the first and second devices using a switching circuit.

19. The method of claim 17, further comprising communicating between the switching circuit and a bridge circuit to determine division and routing configuration of the second segment.

20. The method of claim 17, further comprising passively dividing and routing the bus between the first and second devices.

21. The method of claim 16, further comprising dividing and routing the second segment between the first and second devices using an apparatus chosen from the group consisting of pull-up resistors, pull-down resistors, configurable DIP switches, physical routing of a plug-in card, or a configuration register.

22. The method of claim 21, wherein the PCB couples portions of the second segment of the bus to each other.

23. The method of claim 21, wherein the PCB includes a plurality of configuration options.

24. The method of claim 23, further comprising inserting different sides of the PCB into the adapter to achieve different configuration options.

25. The method of claim 16, further comprising storing configuration information for the bus in a register coupled to a bridge circuit.

26. The method of claim 25, further comprising storing the configuration information in the register via a multi-bit code.

27. A computer system comprising:
a bus divided into at least two segments;
a first segment of the bus routed to a first device; and
a second segment of the bus routed to a means for dividing and routing the second segment between the first device and a second device.

28. The computer system of claim 27, wherein the means for dividing and routing the second segment communicates with a bridge circuit.

29. The computer system of claim 28, wherein the means for dividing and routing the second segment determines routing information based on a card that exists in the first device.

30. A computer system comprising a bus routed to an adapter capable of dividing the bus into multiple sub-segments, and wherein the adapter dynamically allocates the multiple sub-segments between a first device and a second device based upon configuration rules of the first and second devices.

31. The computer system of claim 30, wherein the configuration rules further include a criterion chosen from the group consisting of maximum bandwidth, average usage, and priority.

32. The method of claim 30, further comprising allocating the bus between the first and second devices using an apparatus chosen from the group consisting of pull-up resistors, pull-down resistors, configurable DIP switches, physical routing of a plug-in card, or a configuration register.
